(19) United States
(12) Patent Application Publication
(10) Pub. No.: US 2008/0234985 A1
(43) Pub. Date: Sep. 25, 2008

(54) Non-Adhered Paint Calculation Method and Solvent Weight Calculation Method

(75) Inventors: Takayuki Kuwashima, Aichi (JP); Shinichi Nakane, Aichi (JP); Anhui Cai, Aichi (JP)

Correspondence Address: Muramatsu & Associates, 114 Pacifica, Suite 310, Irvine, CA, 92618, US

(73) Assignee: TRINITY INDUSTRIAL CORPORATION, Aichi (JP)

(21) Appl. No.: 10/586,039

(22) PCT Filed: Jan. 31, 2005
(86) PCT No.: PCT/JP2005/001352

§ 371 Date: Sep. 14, 2006

(30) Foreign Application Priority Data
Feb. 5, 2004 (JP) 2004-029740
Feb. 5, 2004 (JP) 2004-029741

(51) Int. Cl. G06F 17/10; G06F 17/50

(52) U.S. Cl. 703/1; 703/2

(57) ABSTRACT

Appropriate performance design of various mechanisms, e.g. a mist removing filter, employed in post-paint treatment of various mechanisms, e.g. a deodorizer, employed in post-dry treatment is realized. Paint weight calculation is executed. Firstly, the amount of dry adhered paint is calculated by multiplying the work area by a coating thickness distribution value and stored, and the weight of dry adhering paint is calculated by multiplying the amount of dry adhering paint by the specific gravity of the dry paint and stored. Meanwhile, the weight of dry paint or the weight of dry paint sprayed from a paint machine is calculated by multiplying the weight of sprayed paint by a paint NV and stored, the weight of dry non-adhered paint is calculated by subtracting the weight of dry adhering paint from the weight of dry sprayed paint and stored, and then capacities of various mechanisms are designed using it. Furthermore, the amount of dry adhered paint or the volume of dry paint adhered to a work is determined and multiplied by the specific gravity of dry paint to determine the weight of dry adhered paint, which is then divided by the paint NV to determine the solvent weight of adhered paint. Lastly, the VOC weight is determined as the solvent weight of adhered paint by subtracting the weight of dry adhered paint from the weight of adhered paint containing the solvent and employed in designing the capacities of various mechanisms.

### FIELD OF THE INVENTION

The present invention relates to a paint system, and more particularly to a paint system for painting an object to be painted transported by a transporting means in a paint spray booth and then drying the object in a paint drying oven.

### BACKGROUND OF THE INVENTION

A paint spray booth for painting works such as car bodies typically comprises an entrance and an exit at its respective ends as well as a ceiling and a floor, namely, it is structured in a tunnel-like shape. A conveyor is established on the floor for transporting the car bodies one by one. Further, the work painted in the paint spray booth is then transferred to a paint drying oven for drying the paint sprayed on the work, and is dried by the air heated by a heater.

Typically, in the above-explained paint spray booth, it is structured that the air is blown downwardly from the ceiling. As a result of this, the paint mist floating in the painting area flows downwardly. The paint mist is generated because not all of the paint sprayed from a paint machine adhere to the work. Therefore, a post-painting treatment mechanism such as an exhaust mechanism is established on the floor, for example, so that the paint mist in the painting area is properly disposed.

More specifically, water is flown towards the center of the floor, where a scrubber (dust collector) is established to absorb the paint mist floating in the air. The water absorbing the paint is then collected in a disposal vessel called a circulation tank, where the paint is made to settle at the bottom or rise to the surface of the tank to be separated. Further, in the exhaust mechanism, a filter is established so that the paint mist floating in the air can be removed by the filter.

Incidentally, the paint drying oven is so structured that the heated air is blown therein. The work is dried according to this structure, however, solvent, i.e, the volatile organic compound (VOC), is volatilized and mixed in the air at this time. Therefore, a post-drying treatment mechanism such as an exhaust mechanism is established on the ceiling, for example, to properly dispose the VOC.

More specifically, a deodorizing device is established in the exhaust mechanism to burn and remove the paint (see Patent Document 1, for example).

Patent Document 1: Japanese Laid-Open Publication No. 10-071321.

### DISCLOSURE OF THE INVENTION

### Problems to be Solved by the Invention

However, the amount of paint mist and VOC separated and removed by the above-explained processes depends on how efficiently the paint adheres to the work. Here, a paint-adhering efficiency, as will be called hereafter, is a ratio between the amount of paint that adhered to the work and the amount of paint sprayed from the paint machine. The paint-adhering efficiency will change depending on, for example, the shape of the car body.

Due to this, the conventional technology has been using a test piece instead of an actual work to estimate the paint-adhering efficiency from the paint results performed on the test piece. Based on this test, the size of a disposal vessel called a circulation tank, the amount of water flown to the floor, and the performance of the filter in the exhaust mechanism, namely, the performances of various mechanisms used in the post-painting treatment, as well as the performance of the deodorizing device, namely, the capabilities of various mechanisms used in the post-drying treatment are then determined.

However, estimating the paint-adhering efficiency depends, to a large extent, on the experience of workers. Due to this, the paint-adhering efficiency obtained from the results of the test piece would be largely different from the paint-adhering efficiency obtained from the actual work. Therefore, the performances of various mechanisms used in the post-painting and post-drying treatments is typically designed with over specifications, resulting in an increase in financial loss.

The present invention is provided to solve the above-explained problem, with an object to satisfy the appropriate performance design of various mechanisms used in the post-painting and post-drying treatments.

### Means to Solve the Problem

Each means which is appropriate to solve the above object is itemized and explained below. The specific operational effects and the like are also supplemented when necessary.

Means 1: A non-adhered paint calculation method for determining the amount of paint that did not adhere to the object to be painted characterized in that, based on the presumption that at least a coating thickness simulation is executed for calculating a coating thickness distribution value of the paint coating thickness of each portion of the object to be painted, the method is conducted by taking the amount of paint discharged from a paint machine into account while obtaining the amount of paint that adhered to the object to be painted based on the coating thickness distribution value obtained through the coating thickness simulation and a paint area of the object to be painted.

The non-adhered paint calculation method noted in the means 1 presumes the execution of the coating thickness simulation. The coating thickness simulation is to simulate the painting of the object to be painted through a computer system, where at least the coating thickness distribution value, which is the paint coating thickness value at each portion of the object to be painted, is calculated by the simulation.

Therefore, in the present invention, the amount of adhered paint, which is the amount of paint that adhered to the object to be painted, will be determined based on this coating thickness distribution value as well as the paint area. The paint area mentioned here can be obtained with the presumption that it will be calculated as a result of the coating thickness simulation. Further, the paint area can be obtained from drawing data of the object to be painted such as CAD data. Then, further, by considering the amount of discharged paint, which is the amount of paint discharged from the paint machine, the amount of non-adhered paint, which is the amount of paint that did not adhere to the object to be painted, can be calculated.

In other words, the method of calculating the amount of adhered paint is characterized by applying the coating thickness distribution value obtained from the coating thickness simulation. As a consequence, the paint-adhering efficiency can be calculated as a ratio between the amount of the adhered paint and the amount of the discharged paint. Therefore, it is possible to calculate the amount of non-adhered paint.

By using the amount of non-adhered paint obtained in this manner, appropriate performance design for various mechanisms used in the post-painting treatments can be achieved. For example, the performance design such as a size of the disposal vessel called a circulation tank, an amount of water flown to the floor (capability of the scrubber), and a filter in the exhaust mechanism can be appropriately made, becoming economically advantageous since designing with over specifications as done in the conventional technology will no longer be necessary.

Since the specific gravity of the adhered paint, discharged paint, and the non-adhered paint are known in advance, the amounts of the paint can be determined as bulking values or weight values. However, since considering the weight of the solidified paint in the design of various mechanisms used in the post-painting treatments is typical, it is preferable to calculate the dry weight of the non-adhered paint, which is the weight of the dried paint that did not adhere to the object to be painted, as described in the following means.

Means 2: In the non-adhered paint calculation method as noted in the means 1 for calculating dry weight of the non-adhered paint, the amount of non-adhered paint calculated as a bulking value is multiplied by the specific gravity of the paint and a proportion of the solidified paint, or the weight of the non-adhered paint calculated as the weight value is multiplied by the proportion of the solidified paint, thereby calculating the dry weight of the non-adhered paint.

In the above-explained means, the amount of non-adhered paint is calculated as the bulking value or the weight value, as already mentioned. In the means 2, the dry weight of the non-adhered paint is calculated by multiplying the amount of the non-adhered paint by the specific gravity of the paint and the proportion of the solidified paint, or by multiplying the weight of the non-adhered paint by the proportion of the solidified paint. It is presumed that the amount of non-adhered paint mentioned here is obtained as the bulking value prior to drying. As a consequence, it is possible to design the appropriate performances of various mechanisms used in the post-painting treatments.

Incidentally, it is also possible to determine the dry weight of the non-adhered paint through the means described below.

Means 3: Based on the presumption that at least a coating thickness simulation is executed for calculating a coating thickness distribution value of the paint coating thickness of each portion of the object to be painted, the non-adhered paint calculation method for calculating dry weight of the non-adhered paint by the non-adhered paint calculation process comprised of the following procedures (1) and (2).

(1) The coating thickness distribution value obtained in the coating thickness simulation, the paint area of the object to be painted, and the specific gravity of the dried paint are multiplied together to determine dry weight of the adhered paint, which is the dry weight of the paint that adhered to the object to be painted, and the weight of the sprayed paint, which is the weight of the paint sprayed from the paint machine, is multiplied by a proportion of the solidified paint to determine the dry weight of the sprayed paint, which is the dry weight of the paint sprayed from the paint machine.

(2) The dry weight of the adhered paint is subtracted from the dry weight of the sprayed paint to determine the dry weight of the non-adhered paint.

In this case, in the procedure (1), the coating thickness distribution value, the paint area, and the specific gravity of the dried paint are multiplied together to determine the dry weight of the adhered paint, and the weight of the sprayed paint is multiplied by the proportion of the solidified paint to determine the dry weight of the sprayed paint. Then, in the procedure (2), the dry weight of the adhered paint is subtracted from the dry weight of the sprayed paint to determine the dry weight of the non-adhered paint.

As a consequence, the dry weight of the non-adhered paint can be determined, thereby enabling to appropriately design the performances of various mechanisms used in the post-painting treatments.

Here, it is presumed that the coating thickness distribution value mentioned above is obtained as the coating thickness value after drying, however, in the case where the coating thickness value of the paint containing the solvent prior to drying is available, the dry weight of the adhered paint can be determined by multiplying the specific gravity of the paint by the proportion of the solidified paint, instead of the specific gravity of the dried paint.

Means 4: In the non-adhered paint calculation method as described with respect to the means 3, the weight of the sprayed paint in the procedure (1) is calculated by multiplying the amount of sprayed paint, which is the bulking value of the paint sprayed from the paint machine, by the specific gravity of the paint.

As mentioned in the means 4, the weight of the sprayed paint is calculated by multiplying the amount of sprayed paint by the specific gravity of the paint.

Means 5: In the non-adhered paint calculation method as described with respect to the means 3, in the procedure (1), the dry weight of the sprayed paint is determined by multiplying the amount of sprayed paint which is the bulking value of the paint sprayed from the paint machine by the specific gravity of the paint and the proportion of the solidified paint.

In the procedure (1), the weight of the sprayed paint is multiplied by the proportion of the solidified paint to determine the dry weight of the sprayed paint, however, as noted in the means 5, the dry weight of the sprayed paint can be determined by multiplying the amount of sprayed paint by the specific gravity of the paint and the proportion of the solidified paint.

Other than these methods, it is also possible to first obtain the paint-adhering efficiency which is the ratio between the amount of sprayed paint and the amount of adhered paint, and then obtain the dry weight of the non-adhered paint with use of the paint-adhering efficiency.

Means 6: In the non-adhered paint calculation method as described with respect to either one of the means 3-5, in the procedure (1), an integration process is conducted using the coating thickness distribution value and the paint area.

In the above-explained procedure (1), as noted in the means 6, the integration process using the coating thickness distribution value and the paint area is conducted. This is because the coating thickness distribution value is the coating thickness value of each portion of the object to be painted.

Means 7: In the non-adhered paint calculation method as described with respect to either one of the means 1-6, the non-adhered paint calculation process is conducted based on the coating thickness simulation results, when the simulation is repeatedly executed while changing input conditions, by using the simulation result when the paint-adhering efficiency becomes relatively high, where the paint-adhering efficiency is the efficiency of the paint adhering to the object to be painted.

According to the means 7, the coating thickness simulation is repeatedly executed while changing the input conditions. Then, based on the simulation results attained when the paint-adhering efficiency becomes relatively high, the non-adhered paint calculation process is conducted. The input conditions mentioned here are, for example, the amount of sprayed paint from the paint machine per unit hour or the traveling speed of the paint sprayed from the paint machine, etc. In other words, the paint-adhering efficiency, namely, the coating thickness distribution value, changes depending on the input conditions of the coating thickness simulation. Therefore, by using the simulation results when the paint-adhering efficiency becomes relatively high, the amount of non-adhered paint becomes small. As a result, the performances of various mechanisms used in the post-painting treatment can be designed in a relatively low, which is economically advantageous.

In the foregoing, the present invention has been explained as the non-adhered paint calculation method, however, the present invention can also be fulfilled as a non-adhered paint calculation apparatus for performing a non-adhered paint calculation process. Since the operation and its effects are the same as the operation and effects explained with respect to the non-adhered paint calculation method, explanation of which will be omitted.

Means 8: With reference to at least the results of coating thickness simulation executed for calculating a coating thickness distribution value of the paint coating thickness of each portion of the object to be painted, a non-adhered paint calculation apparatus is provided with a process execution means for performing the non-adhered paint calculation process comprised of procedures (1) and (2) explained below and calculating the dry weight of the non-adhered paint which is the dry weight of the paint that did not adhere to the object to be painted.

(1) The coating thickness distribution value obtained in the coating thickness simulation, the paint area of the object to be painted, and the specific gravity of the dried paint are multiplied together to determine the dry weight of the adhered paint, which is the dry weight of the paint that adhered to the object to be painted, and the weight of the sprayed paint, which is the weight of the paint sprayed from the paint machine, is multiplied by the proportion of the solidified paint to determine the dry weight of the sprayed paint, which is the dry weight of the paint sprayed from the paint machine.

(2) The dry weight of the adhered paint is subtracted from the dry weight of the sprayed paint to determine the dry weight of the non-adhered paint.

Means 9: In the non-adhered paint calculation apparatus as described with respect to the means 8, the weight of the sprayed paint in the procedure (1) is calculated by multiplying the amount of sprayed paint, which is the bulking value of the paint sprayed from the paint machine, by the specific gravity of the paint.

Means 10: In the non-adhered paint calculation apparatus as described with respect to the means 8, in the procedure (1), the dry weight of the sprayed paint is determined by multiplying the amount of the sprayed paint which is the bulking value of the paint sprayed from the paint machine by the specific gravity of the paint and the proportion of the solidified paint.

Means 11: In the non-adhered paint calculation apparatus as described with respect to either one of the means 8-10, the process execution means executes the integration process using the coating thickness distribution value and the paint area in the procedure (1).

Means 12: In the non-adhered paint calculation apparatus as described with respect to either one of the means 9-11, the process execution means executes the non-adhered paint calculation process based on the coating thickness simulation results, when the simulation is repeatedly executed while changing input conditions, by using the simulation result attained when the paint-adhering efficiency becomes relatively high, where the paint-adhering efficiency is the efficiency of the paint adhering to the object to be painted.

The above-explained non-adhered paint calculation process can be implemented by a program executed by a computer system, and by this meaning, the present invention can be implemented as a program shown below or as an invention of a recording medium. The recording medium can be a CD-ROM, DVD-ROM, and an MO, but can also be an HD, ROM, or RAM built in a computer system.

Means 13: A non-adhered paint calculation program for implementing the non-adhered paint calculation method as described with reference to the means 1-7 or the non-adhered paint calculation process of the non-adhered paint calculation apparatus as described with reference to either one of the means 8-12 in a computer system.

Means 14: A recording medium recorded with the non-adhered paint calculation program as described with reference to the means 13.

Means 15: Based on the presumption that at least a coating thickness simulation is executed for calculating a coating thickness distribution value of the paint coating thickness of each portion of the object to be painted, a solvent weight calculation method is characterized in determining the amount of paint adhered to the object to be painted based on the coating thickness distribution value obtained from the coating thickness simulation and the paint area of the object to be painted, and calculating the solvent weight of the paint adhered to the object to be painted based on the amount of adhered paint.

In the solvent weight calculation method as described with reference to the means 15, it is presumed that the coating thickness simulation is performed. The coating thickness simulation simulates the painting of the object by a computer system, and by this simulation, the coating thickness distribution value, which is the coating thickness of each portion of the object to be painted, is calculated.

Therefore, in the present invention, the amount of paint adhered to the object to be painted is determined based on the coating thickness distribution value and the paint area. It is presumed that the paint area mentioned here is calculated as a result of the coating thickness simulation. Further, the paint area can also be obtained from the drawing data such as CAD data of the object to be painted. Furthermore, based on this amount of adhered paint, the solvent weight of the adhered paint, which is the solvent weight of the paint adhered to the object to be painted, is calculated.

In other words, this invention is characterized to calculate the amount of adhered paint by using the coating thickness distribution value obtained from the coating thickness simulation. By using this adhered solvent weight, appropriate performance design of various mechanisms used in the post-drying treatment can be satisfied. For example, the capability design of the deodorizing device becomes appropriate, thus, designing with over specifications as done in the conventional technology becomes unnecessary, which is economically advantageous.

Since the specific gravity of the adhered paint is known in advance, the amount of adhered paint can be determined as the bulking value or weight value.

Incidentally, it is also possible to determine the dry weight of the non-adhered paint through the means described below.

Means 16: Based on the presumption that at least a coating thickness simulation is executed for calculating a coating thickness distribution value of the paint coating thickness of each portion of the object to be painted, a solvent weight calculation method is characterized in calculating the weight of the adhered solvent, which is the weight of the solvent adhered to the object to be painted, by the solvent weight calculation process comprised of the following procedures (1)-(4).

(1) The coating thickness distribution value obtained from the coating thickness simulation is multiplied by the paint area of the object to be painted to determine the amount of the dried adhered paint, which is the bulking value of the dried paint adhered to the object to be painted.

(2) the amount of dried adhered paint is multiplied by the specific gravity of the dried paint to determine the dry weight of the adhered paint, which is the weight of the dried paint adhered to the object to be painted.

(3) The dry weight of the adhered paint is divided by the proportion of the solidified paint to determine the weight of the adhered paint, which is the weight of the paint adhered to the object to be painted.

(4) The dry weight of the adhered paint is subtracted from the weight of the adhered paint to determine the solvent weight of the adhered paint.

In this case, in the procedure (1), the coating thickness distribution value is multiplied by the paint area to determine the amount of the dried adhered paint. Next, in the procedure (2), the dry weight of the adhered paint is determined by using the specific gravity of the dried paint. In the next procedure (3), the dry weight of the adhered paint is divided by the proportion of the solidified paint to determine the weight of the adhered paint. Then, in the procedure (4), the dry weight of the adhered paint is subtracted from the weight of the adhered paint to determine the solvent weight of the adhered paint.

As a consequence, the solvent weight of the adhered paint is determined, and the appropriate performance design of various mechanisms used in the post-drying treatment can be satisfied.

Means 17: Based on the presumption that at least a coating thickness simulation is executed for calculating a coating thickness distribution value of the paint coating thickness of each portion of the object to be painted, a solvent weight calculation method is characterized in calculating the solvent weight of the adhered paint, which is the weight of the solvent of the paint adhered to the object to be painted, by the solvent weight calculation process comprised of the following procedures (1)-(3).

(1) The coating thickness distribution value obtained from the coating thickness simulation, the paint area of the object to be painted, and the specific gravity of the dried paint are multiplied together to determine the dry weight of the adhered paint.

(2) The dry weight of the adhered paint is divided by the proportion of the solidified paint to determine the weight of the adhered paint which is the weight of the paint adhered to the object to be painted.

(3) The dry weight of the adhered paint is subtracted from the weight of the adhered paint to determine the solvent weight of the adhered paint.

In this case, as explained in the procedure (1), the coating thickness distribution value, the paint area, and the specific gravity of the dried paint are multiplied together to determine the dry weight of the adhered paint. Next, in the procedure (2), the dry weight of the adhered paint is divided by the proportion of the solidified paint to determine the weight of the adhered paint. Then, in the procedure (3), the dry weight of the adhered paint is subtracted from the weight of the adhered paint to determine the solvent weight of the adhered paint.

As a consequence, the solvent weight of the adhered paint is determined, and the appropriate performance design of various mechanisms used in the post-drying treatment can be satisfied.

The dry weight of the adhered paint is subtracted in the above procedure (3), however, if the weight of the adhered paint consisting of the solvent is known, the weight of the adhered solvent can be determined by multiplying the weight of the adhered paint by the proportion of the non-solidified paint. In other words, the procedure (3) can be worded as “the weight of the adhered paint is multiplied by the proportion of the non-solidified paint to determine the solvent weight of the adhered paint”. In this case, since the dry weight of the adhered paint is not necessary, the following method can be achieved.

Means 18: Based on the presumption that at least a coating thickness simulation is executed for calculating a coating thickness distribution value of the paint coating thickness of each portion of the object to be painted, a solvent weight calculation method is characterized in calculating the solvent weight of the adhered paint, which is the weight of the solvent of the paint adhered to the object to be painted, by the solvent weight calculation process comprised of the following procedures (1) and (2).

(1) The coating thickness distribution value obtained from the coating thickness simulation, the paint area of the object to be painted, and the specific gravity of the dried paint are multiplied together, and further, divided by the proportion of the solidified paint to determine the weight of the adhered paint which is the weight of the paint adhered to the object to be painted.

(2) The weight of the adhered paint is multiplied by the proportion of the non-solidified paint to determine the solvent weight of the adhered paint.

In this case, in the procedure (1), the coating thickness distribution value, the paint area of the object to be painted, and the specific gravity of the dried paint are multiplied together, and further, divided by the proportion of the solidified paint to determine the weight of the adhered paint. Then, in the procedure (2), the weight of the adhered paint is multiplied by the proportion of the non-solidified paint to determine the solvent weight of the adhered paint. Since the proportion of the solidified paint (paint NV) is already known, the proportion of the non-solidified paint can be calculated as (1-paint NV).

As a consequence, the solvent weight of the adhered paint is determined, and the appropriate performance design of various mechanisms used in the post-drying treatment can be satisfied.

Means 19: In the solvent weight calculation method as described with respect to either one of the means 16-18, an integration process using the coating thickness distribution value and the paint area is performed in the procedure (1).

In the above-explained procedure (1), as described in the means 19, the integration process using the coating thickness distribution value and the paint area is executed. This is because the coating thickness distribution value is the coating thickness value of each portion of the object to be painted.

Means 20: In the solvent weight calculation method as described with reference to either one of the means 15-19, the solvent weight calculation process is performed based on the coating thickness simulation results, when the simulation is repeatedly executed while changing input conditions, by using the simulation result attained when the paint-adhering efficiency becomes relatively high, where the paint-adhering efficiency is the efficiency of the paint adhering to the object to be painted.

According to the means 20, the coating thickness simulation is repeatedly executed while changing the input condition. Then, based on the simulation results obtained when the paint-adhering efficiency becomes relatively high, the solvent weight calculation process is executed. The input condition mentioned here is, for example, the amount of paint sprayed from the paint machine per unit hour or the traveling speed of the paint sprayed from the paint machine, etc. In other words, the paint-adhering efficiency, namely, the coating thickness distribution value changes depending on the input condition of the coating thickness simulation. Therefore, by using the simulation results when the paint-adhering efficiency becomes high, the amount of adhered paint also becomes large. A high paint-adhering efficiency is economically advantageous, however, the amount of solvent in the post-drying treatment increases as well. As a consequence, the various mechanisms used in the post-drying treatment can be designed with sufficient capabilities.

In the foregoing, the present invention has been explained as a solvent weight calculation method, however, a solvent weight calculation apparatus for executing a solvent weight calculation process as described above can be fulfilled as well. Since its operation and effects are similar to the operation and effects explained in the solvent weight calculation method, explanation of which will be omitted.

Means 21: With reference to at least a result of a coating thickness simulation executed for calculating a coating thickness distribution value of the paint coating thickness of each portion of the object to be painted, a solvent weight calculation apparatus provided with a process execution means for executing the solvent weight calculation process comprised of the following procedures (1)-(4) and calculating the solvent weight of the adhered paint, which is the weight of the solvent of the paint adhered to the object to be painted.

(1) The coating thickness distribution value obtained from the coating thickness simulation is multiplied by the paint area of the object to be painted to determine the amount of dried adhered paint, which is the bulking value of the dried paint adhered to the object to be painted.

(2) The amount of dried adhered paint is multiplied by the specific gravity of the dried paint to determine the dry weight of the adhered paint.

(3) The dry weight of the adhered paint is divided by the proportion of the solidified paint to determine the weight of the adhered paint which is the weight of the paint adhered to the object to be painted.

(4) The dry weight of the adhered paint is subtracted from the weight of the adhered paint to determine the solvent weight of the adhered paint.

Means 22: With reference to at least a result of a coating thickness simulation executed for calculating a coating thickness distribution value of the paint coating thickness of each portion of the object to be painted, a solvent weight calculation apparatus provided with a process execution means for executing the solvent weight calculation process comprised of the following procedures (1)-(3) and calculating the solvent weight of the adhered paint.

(1) The coating thickness distribution value obtained from the coating thickness simulation, the paint area of the object to be painted, and the specific gravity of the dried paint are multiplied together to determine the dry weight of the adhered paint.

(2) the dry weight of the adhered paint is divided by the proportion of the solidified paint to determine the weight of the adhered paint.

(3) The dry weight of the adhered paint is subtracted from said weight of the adhered paint to determine the solvent weight of the adhered paint.

Means 23: With reference to at least a result of a coating thickness simulation executed for calculating a coating thickness distribution value of the paint coating thickness of each portion of the object to be painted, a solvent weight calculation apparatus provided with a process execution means for executing the solvent weight calculation process comprised of the following procedures (1) and (2) and calculating the solvent weight of the adhered paint.

(1) The coating thickness distribution value obtained from the coating thickness simulation, the paint area of the object to be painted, and the specific gravity of the dried paint are multiplied together, and further, divided by the proportion of the solidified paint to determine the weight of the adhered paint.

(2) The weight of the adhered paint is multiplied by the proportion of the non-solidified paint to determine the solvent weight of the adhered paint.

Means 24: In the solvent weight calculation apparatus as described with reference to either one of the means 21-23, in the procedure (1), the process execution means executes an integration process using the coating thickness distribution value and the paint area.

Means 25: In the solvent weight calculation apparatus as described with reference to either one of the means 21-24, the solvent weight calculation process is performed by the process execution means based on the coating thickness simulation results, when the simulation is repeatedly executed while changing input conditions, by using the simulation result obtained when the paint-adhering efficiency becomes relatively high, where the paint-adhering efficiency is the efficiency of the paint adhering to the object to be painted.

The solvent weight calculation process explained above can be implemented by a program executed by a computer system, and by this meaning, the present invention can be implemented as a program shown below or as an invention of a recording medium. The recording medium can be a CD-ROM, DVD-ROM, and an MO, but can also be an HD, ROM, or RAM built in a computer system.

Means 26: A solvent weight calculation program for implementing the solvent weight calculation method as described with reference to either one of the means 15-20 or the solvent weight calculation process of the solvent weight calculation apparatus as described with reference to either one of the means 21-25 in the computer system.

Means 27: A recording medium recorded with the solvent weight calculation program as described with reference to the means 26.

### Preferred Embodiments of the Invention

The calculation of the weight of the solidified paint (paint mist) that did not adhere to the object to be painted as well as the weight of the volatile organic compound (VOC) generated when drying the object to be painted will be explained in detail below with reference to the drawings.

First, the overview of the paint system will be explained based on FIG. 1, and then the structure and process of the apparatus will be explained in detail.

FIG. 1 is a schematic explanatory diagram showing the post-painting treatment and the post-drying treatment of the paint system.

The paint system of the present embodiment includes a tunnel-shaped paint spray booth 10. The paint spray booth 10 is comprised of an entrance and an exit at respective ends, as well as a ceiling 11 and a floor 12. A conveyor 14 for transferring the work 13, which is a car body, is installed near the floor 12. The work 13 is transported in the direction as shown by an arrow J by the conveyor 14.

In such a paint spray booth 10, a paint machine 15 for spraying the paint is established, where the paint machine 15 is controlled by a predetermined control program for painting the work 13.

Here, not all of the paint sprayed from the paint machine 15 will adhere to the work 13, leaving the non-adhered paint floating in the paint spray booth 10. Thus, an airflow called a down flow is generated in the paint spray booth 10. This airflow is an external air brought in through the air adjuster 16 and is generated by an A-fan 31. This airflow is comparatively calm, and is generated from the ceiling 11 to the floor 12 (in the direction shown by a letter K in the drawing). As a result, the paint that did not adhere to the work 13, namely, the paint mist floating in the paint spray booth 10 will be moved towards the floor 12. FIG. 1 of the present embodiment shows a total of six fans 31, 32, 33, 34, 35, and 36, however, in order to differentiate them from one another, letters A-F will be added for convenience to note them as “A-fan 31”, “B-fan 32”, “C-fan 33”, “D-fan 34”, “E-fan 35”, and “F-fan 36”, respectively.

The floor 12 is gently sloped towards the center, in which a water flow is generated by a pump 37. The direction of the water flow is shown by the letter L. This water falls through the center of floor 12. From this structure, a scrubber (dust collector) is formed for absorbing the paint mist falling through floor 12.

Therefore, a part of the paint mist that has moved near the floor 12 is absorbed here and then accumulated in the circulation tank 17 to be removed by making it rise to the surface or settle at the bottom thereof. When the paint mist is removed from the circulation tank 17, the remaining water is once again pumped through the pump 37 to generate the water flow on the floor 12.

Further, the paint mist that was not absorbed by the scrubber is exhausted along with the air from the paint spray booth 10 by the B-fan 32. A mist-eliminating filter 18 is established at the end of the B-fan 32, where the paint mist that is floating in the air is removed. A part of the paint mist-free air is released into the atmosphere and the remaining part thereof is sent to the paint spray booth 10 by the A-fan 31.

Meanwhile, the work 13 that has finished being painted in the paint spray booth 10 is transferred to the drying oven 20 by the conveyor 14. In the drying oven 20, the air heated by the heater 21 is blown on the work 13 by the D-fan 34. At this time, the volatile organic compound (VOC), which is the solvent adhered to the work 13, is volatilized. This VOC is sent to the deodorizing device 22 by the E-fan 35, and then burned out. A part of the VOC-free air is released into the atmosphere, and the remaining air thereof is sent to the heater 21 along with fresh air from the outside.

In the paint system constructed in such a manner, proper removal of the paint mist and VOC is required. Namely, appropriate design of various mechanisms for conducting the removal of the paint mist and VOC such as the amount of water flown to the floor 12 (the scrubber capability), the size of the circulation tank 17, the size of the mist-eliminating filter 18, and the size of the deodorizing device 22 becomes important.

FIG. 2 is an explanatory view showing the schematic structure of the weight calculation apparatus 1 of the present embodiment. The weight calculation apparatus 1 is constructed as a computer system which includes a main body 50, a monitor 60, and a keyboard 70.

The main body 50 is configured by a CPU 51, a ROM 52, a RAM 53, an input mechanism 54, and an output mechanism 55. The CPU 51 that is a central processor operates based on the programs stored in the ROM 52 and RAM 53, and controls the entire apparatus. Here, the RAM 53 also functions as a temporary memory means for temporarily storing the calculated results from the calculation process explained hereafter.

The monitor 60 is a display device made of liquid crystal or CRT, and the keyboard 70 is an input device for an operator to input information.

In the present embodiment, the paint weight calculation process as well as the solvent weight calculation process explained hereafter can be conducted by such a computer system based on the coating thickness simulation results entered through the above-explained input mechanism 54. Accordingly, based on the calculated results of each process, the size of the circulation tank 17, the amount of water flown to the floor 12 (the scrubber capability), and the capabilities of the mist-eliminating filter 18 and the deodorizing device 22 are determined. In the present embodiment, the coating thickness simulation is repeatedly conducted, and by using the simulation results at the time when the paint-adhering efficiency becomes relatively high, where the paint-adhering efficiency is an efficiency of the paint that adhered to the work 13, the paint weight calculation process and the solvent weight calculation process are carried out.

Next, the paint weight calculation process carried out by the weight calculation apparatus 1 will be explained. FIG. 3 is a flow chart showing the paint weight calculation process. This paint weight calculation process is executed by the CPU 51 based on the program stored in the ROM 52.

In the first step 100 (hereafter, each step is simply referred to as a letter S), the coating thickness distribution value will be obtained. This process obtains the coating thickness distribution value, which is the result from the coating thickness simulation. In the present embodiment, this is entered through the input mechanism 54 of the weight calculation apparatus 1. It is presumed that the coating thickness distribution value is obtained as the coating thickness value of the paint after the paint has been dried.

In the next S110, the work area is obtained. This process obtains the paint area of the work, and in the present embodiment, it is entered through the input mechanism 54 of the weight calculation apparatus 1 as the result of the coating thickness simulation. It is also possible that the work area can be obtained through the drawing data such as CAD data as well.

In the following S120, the work area and the coating thickness distribution value are multiplied together. Since the coating thickness distribution value is the coating thickness value of each portion of the work 13, an integration process is conducted here to determine the bulking value of the paint adhered to the work 13 after being dried. Then, in the next S130, the amount of the dried adhered paint determined in S120 is recorded. In the present embodiment, this data is stored in the RAM 53 of the weight calculation apparatus 1. The calculation results in the following processes will be stored in the RAM 53 as well.

In the following S140, the amount of the dried adhered paint and the specific gravity of the dried paint are multiplied together to calculate the weight value of the paint that has adhered to the work 13. The specific gravity of the dried paint is the weight per unit volume of the dried paint. Then, in the next S150, the weight of the dried adhered paint calculated in S140 is recorded.

In the following S160, the weight of the sprayed paint is multiplied by a paint NV (the solidified paint proportion). The weight of the sprayed paint is the weight value of the paint sprayed from the paint machine 15, and the paint NV is the proportion of the solid paint. In the following S170, the dry weight of the sprayed paint calculated in S160 is recorded. The weight of the sprayed paint can be calculated by multiplying the amount of sprayed paint, which is the bulking value of the paint sprayed from the paint machine 15, by the specific gravity of the paint. Further, instead of the process indicated by the S160, the specific gravity of the paint and the paint NV can be multiplied by the amount of sprayed paint itself to determine the dry weight of the sprayed paint.

In the following S180, the dry weight of the adhered paint recorded in S150 is subtracted from the dry weight of the sprayed paint recorded in S170. As a result, the dry weight of the paint that did not adhere to the work 13 can be determined, where in the following S190, this will be recorded as the dry weight of the non-adhered paint.

Next, the solvent weight calculation process conducted in the weight calculation apparatus 1 will be explained. FIG. 4 is a flow chart showing the solvent weight calculation process. This solvent weight calculation process is executed by the CPU 51 based on the program stored in the ROM 52.

In the first S300, the coating thickness distribution value is obtained. This process obtains the coating thickness distribution value, which is the result from the coating thickness simulation. In the present embodiment, this is entered through the input mechanism 54 of the weight calculation apparatus 1. The coating thickness distribution value is obtained as the coating thickness value of the paint after being dried.

In the next S310, the work area is obtained. This process obtains the paint area of the work, and in the present embodiment, it is entered through the input mechanism 54 of the weight calculation apparatus 1 as the result of the coating thickness simulation. The work area can be obtained from the drawing data such as CAD data as well.

In the following S320, the work area and the coating thickness distribution value are multiplied together. Since the coating thickness distribution value is the coating thickness value of each portion of the work 13, an integration process is conducted here to determine the bulking value of the paint adhered to the work 13 after being dried. Then, in the next S330, the amount of the dried adhered paint determined in S320 is recorded.

In the following S340, the amount of dried adhered paint recorded in S330 is multiplied by the specific gravity of the dried paint. By multiplying it by the specific gravity of the dried paint, the dry weight of the adhered paint can be obtained. In the next S350, the dry weight of the adhered paint determined in S340 is recorded.

In the following 360, the dry weight of the adhered paint is divided by the paint NV. As a consequence, the weight of the adhered paint including the solvent can be obtained. In the following S370, the weight of the adhered paint determined in S360 is recorded.

Then, in the following S380, the dry weight of the adhered paint recorded in S350 is subtracted from the weight of the adhered paint recorded in S370. From this, the amount of solvent is determined, where in S390, this amount will be recorded as the VOC weight.

Next, the effects achieved by the weight calculation apparatus 1 in the present embodiment will be explained.

In the present embodiment, the dry weight of the adhered paint, which is the weight of the paint adhered to the work 13 after being dried, is determined based on the coating thickness distribution value obtained as the result of the coating thickness simulation and the work area. Then, further, by considering the dry weight of the sprayed paint, which is the dry weight of the paint sprayed from the paint machine 15, the dry weight of the non-adhered paint, which is the dry weight of the paint that did not adhere to work 13, is calculated.

More specifically, the paint weight calculation process shown in FIG. 3 is conducted, where the work area and the coating thickness distribution value are multiplied together to calculate the amount of the dried adhered paint and record it (S120, S130), and the specific gravity of the dried paint is multiplied by the amount of dried adhered paint to calculate the dry weight of the adhered paint and record it (S140, S150). On the other hand, the weight of the sprayed paint is multiplied by the paint NV to calculate the dry weight of the sprayed paint and record it (S160, S170). Then, the dry weight of the adhered paint is subtracted from the dry weight of the sprayed paint to calculate the dry weight of the non-adhered paint and record it (S180, S190).

By using this dry weight of the non-adhered paint, the appropriate performance design of various mechanisms used in the post-painting treatment can be satisfied. For example, the appropriate design of the size of the circulation tank 17, the amount of water flown to the floor 12 (the scrubber capability), and the size of the mist-eliminating filter 18 become appropriate, thus, achieving an economic advantage since over specifications in the design as done in the conventional technology is no longer necessary.

Further, in the present embodiment, the paint weight calculation process is conducted by using the simulation results at the time when the paint-adhering efficiency, which is the efficiency of the paint adhering to the work 13, becomes relatively high, by repeatedly executing the coating thickness simulation while changing the input conditions. Since the paint-adhering efficiency, namely, the coating thickness distribution value changes depending on the input conditions of the coating thickness simulation, by using the simulation results when the paint-adhering efficiency becomes relatively high, the amount of non-adhered paint will become small. As a result, the performances of various mechanisms used in the post-painting treatments can be designed in a manner of relatively low level, which is economically advantageous.

Incidentally, the weight calculation apparatus 1 of the present embodiment corresponds to “the non-adhered paint calculation apparatus” noted above, and the CPU 51 of the main body 50 corresponds to “the process execution means” noted above. Further, the paint weight calculation process explained above corresponds to “the non-adhered paint calculation process” noted above.

Further, in the present embodiment, the amount of dried adhered paint, which is the bulking value of the dried paint adhered to the work 13, is determined based on the coating thickness distribution value obtained as a result of the coating thickness simulation and the work area (S300-S330 in FIG. 4). Then, the amount of dried adhered paint is multiplied by the specific gravity of the dried paint to determine the dry weight of the adhered paint (S340, S350), where the dry weight of the adhered paint is divided by the paint NV to determine the weight of the adhered paint including the solvent (S360, S370). The dry weight of the adhered paint is subtracted from the weight of the adhered paint to determine the VOC weight used as the weight of the adhered solvent (S380, S390).

By using this VOC weight, the appropriate performance design of various mechanisms used in the post-drying treatments can be satisfied. For example, the performance design of the size of the deodorizing device 22 becomes appropriate, thus becoming economically advantageous by not requiring over specifications in the design as done in the conventional technology.

Further, in the present embodiment, the paint weight calculation process and the solvent weight calculation process are conducted by using the coating thickness simulation results attained when the paint-adhering efficiency becomes relatively high by repeatedly executing the coating thickness simulation while changing the input conditions. Since the paint-adhering efficiency, namely, the coating thickness distribution value changes depending on the input conditions of the coating thickness simulation, by using the simulation results at the time when the paint-adhering efficiency becomes relatively high, the amount of the adhered paint becomes large. When the paint-adhering efficiency becomes high, it becomes economically advantageous, however, the solvent (VOC weight) in the post-drying treatment becomes large as well. Therefore, according to the present embodiment, the performance of various mechanisms used in the post-drying treatment can be designed in a sufficient manner.

Incidentally, the weight calculation apparatus 1 of the present embodiment corresponds to “the solvent weight calculation apparatus” noted above, and the CPU 51 of the main body 50 corresponds to “the process execution means” noted above. Further, the solvent weight calculation process explained above corresponds to “the solvent weight calculation process” noted above.

The present invention is not limited to the above embodiment, and can be implemented in various embodiments without departing from the essence of the present invention.

(a) For example, the calculation process for the dry weight of the adhered paint in FIG. 3 (S120-S150) can be conducted after the calculation process for the dry weight of the sprayed paint (S160-S170).

(b) Further, for example, in the above embodiment, the coating thickness distribution value obtained as a result of the coating thickness simulation is the coating thickness value of the paint coat after it has been dried. Due to this, in S140 in FIG. 3, it is multiplied by the specific gravity of the dried paint to determine the dry weight of the adhered paint.

On the other hand, the coating thickness value of the paint coat including the solvent before the paint is dried can be used instead. In such a case, instead of the process mentioned in S140, the amount of adhered paint including the solvent is multiplied by the specific gravity of the paint and the paint NV to determine the dry weight of the adhered paint.

(c) For example, instead of the process mentioned in S380 in FIG. 4, the weight of the adhered paint is multiplied by (1-paint NV) to determine the VOC weight. In such a case, since the dry weight of the adhered paint does not have to be calculated, the calculation process in S320, S340, and S360 can be conducted in one step where only the weight of the adhered paint is recorded.

(d) Further, for example, in the present embodiment, the amount of the dried adhered paint is determined by the calculation process in S320, however, the calculation process in S320 and S340 can be conducted by one step, and the amount of the dried adhered paint does not have to be determined.

(e) In the above embodiment, the coating thickness distribution value obtained as a result of the coating thickness simulation is the coating thickness value of the paint coat after it has been dried. Due to this, the dry weight of the adhered paint is determined (S340, S350), and furthermore, divided by the paint NV to determine the weight of the adhered paint including the solvent (S360, S370).

On the other hand, the coating thickness value of the paint coat including the solvent before the paint is dried can be used. In such a case, since the amount of adhered paint including the solvent is determined first, it can be multiplied by the specific gravity of the paint, and then, by the proportion of the non-solidified paint (1-paint NV) to determine the VOC weight.

### BRIEF DESCRIPTION OF THE DRAWINGS

FIG. 1 is a schematic explanatory view showing the post-painting treatment as well as the post-drying treatment in the paint system.

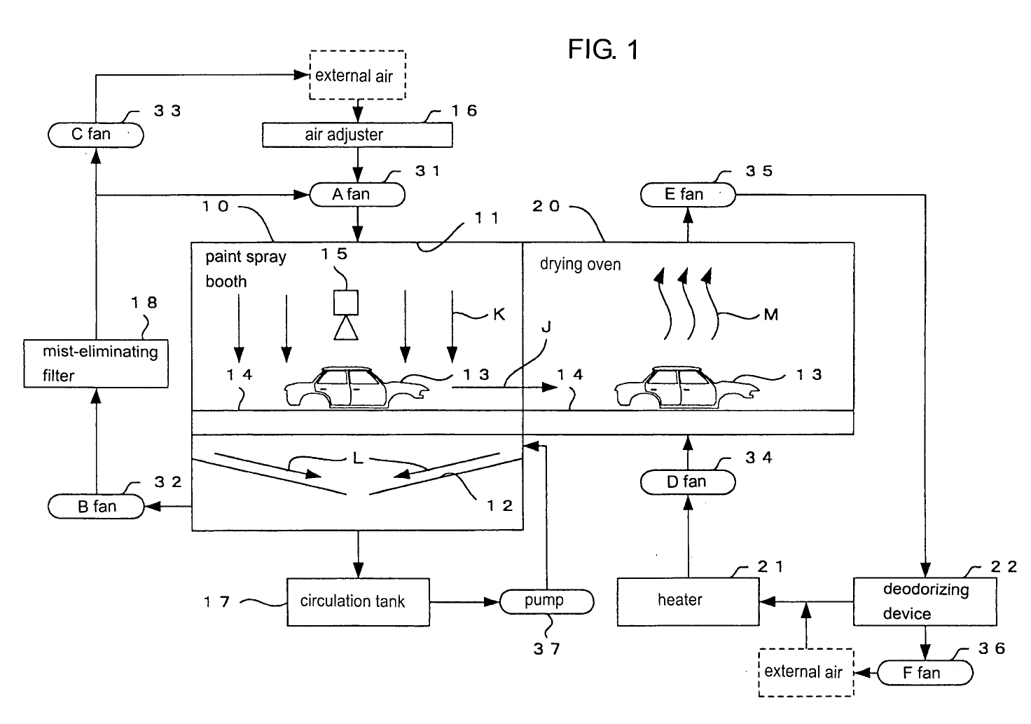

FIG. 2 is an explanatory view showing the schematic structure and the overall operation of the weight calculation apparatus 1.

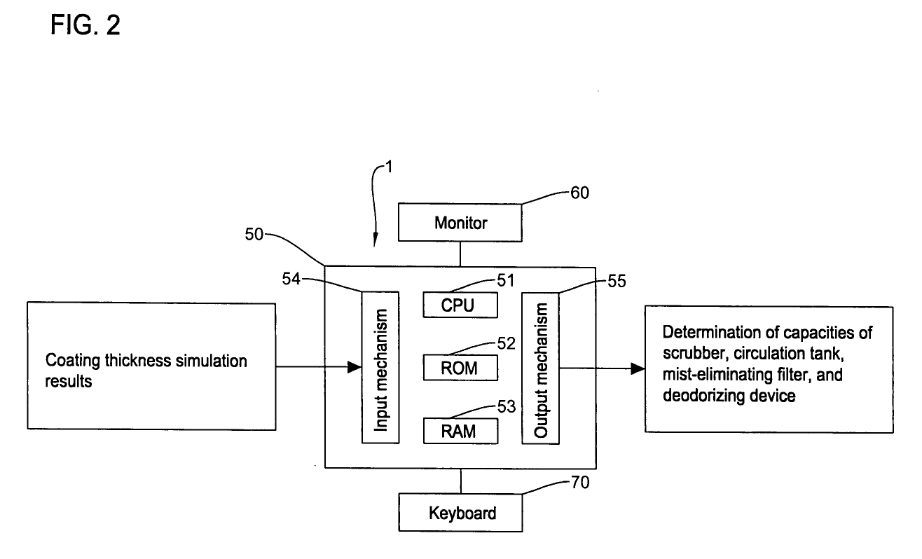

FIG. 3 is a flow chart showing the paint weight calculation process.

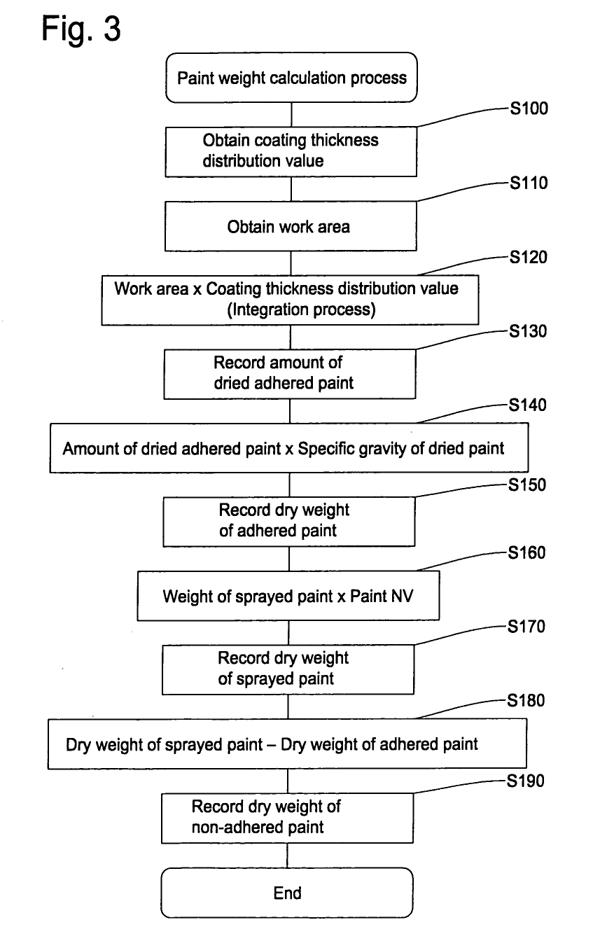

FIG. 4 is a flow chart showing the solvent weight calculation process.

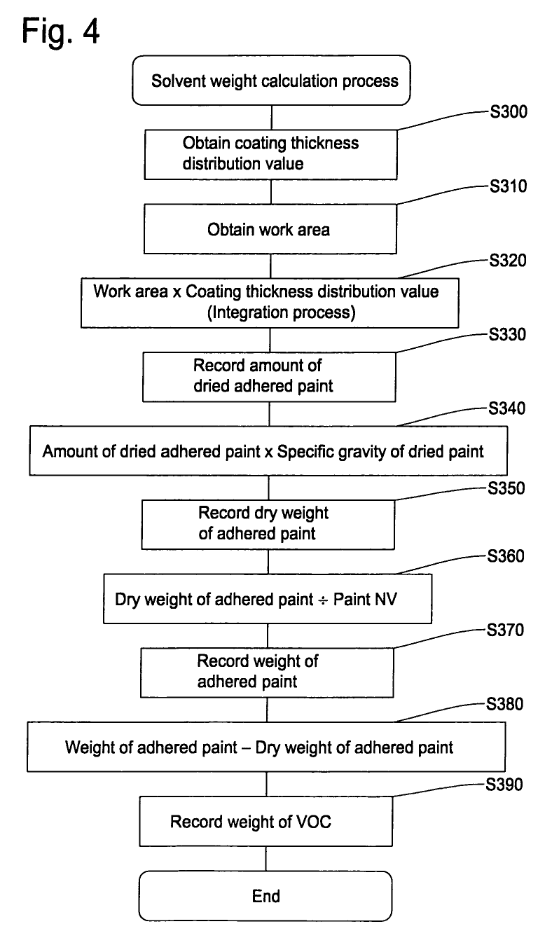

### EXPLANATION OF REFERENCE LABELS

1 Weight calculation apparatus used as the non-adhered paint calculation apparatus and solvent weight calculation apparatus
10 Paint spray booth
11 Ceiling
12 Floor
13 Work used as the object to be painted
14 Conveyor
15 Paint machine
16 Air adjuster
17 Circulation tank
18 Mist-eliminating filter
20 Drying oven
21 Heater
22 Deodorizing device
31-36 Fan
37 Pump
50 Main body
51 CPU used as the process execution means
52 ROM
53 RAM
54 Input mechanism
55 Output mechanism
60 Monitor
70 Keyboard

1. A non-adhered paint calculation method using a non-adhered paint calculation process, characterized in that:
presuming that at least a coating thickness simulation is executed for calculating a coating thickness distribution value of paint coating thickness of each portion of an object to be painted;
determining an amount of adhered paint, which is the paint adhered to the object to be painted, based on the coating thickness distribution value obtained from the coating thickness simulation and a paint area of the object to be painted;
considering an amount of sprayed paint which is the paint that has been discharged from a paint machine; and
calculating an amount of non-adhered paint which is the paint that did not adhere to the object to be painted.

2. A non-adhered paint calculation method as defined in claim 1, characterized in that dry weight of the non-adhered paint is calculated by multiplying the amount of non-adhered paint by specific gravity of the paint and a proportion of solidified paint, or multiplying weight of the non-adhered paint by the proportion of the solidified paint.

3. A non-adhered paint calculation method for calculating dry weight of non-adhered paint, which is the dry weight of the paint that did not adhere to an object to be painted, characterized in that a non-adhered paint calculation process comprised of the following procedures (1) and (2) based on the presumption that at least a coating thickness simulation is executed for calculating a coating thickness distribution value of paint coating thickness of each portion of the object to be painted:
(1) Said coating thickness distribution value obtained from said coating thickness simulation, a paint area of the object to be painted, and specific gravity of dried paint are multiplied together to determine dry weight of the adhered paint, and weight of sprayed paint is multiplied by a proportion of solidified paint to determine dry weight of the sprayed paint, and
(2) Said dry weight of the adhered paint is subtracted from said dry weight of the sprayed paint to determine said dry weight of the non-adhered paint.

4. A non-adhered paint calculation method as defined in claim 3, characterized in that the weight of the sprayed paint in said procedure (1) is calculated by multiplying the amount of the sprayed paint, which is a bulking value of the paint sprayed from a paint machine, by the specific gravity of the paint.

5. A non-adhered paint calculation method as defined in claim 3, characterized in that said dry weight of the sprayed paint is calculated by multiplying the amount of sprayed paint by the specific gravity of the paint and the proportion of the solidified paint in said procedure (1).

6. A non-adhered paint calculation method as defined in either one of claims 3-5, characterized in that said procedure (1) conducts an integration process using said coating thickness distribution value and said paint area.

7. A non-adhered paint calculation method as defined in either one of claims 1-5, characterized in that said non-adhered paint calculation process is conducted based on the coating thickness simulation results at a time when a paint-adhering efficiency, which is an efficiency of the paint adhering to the object to be painted, becomes relatively high by repeatedly executing said coating thickness simulation while changing input conditions.

8. A solvent weight calculation method using a solvent weight calculation process, characterized in that:
presuming that at least a coating thickness simulation is executed for calculating a coating thickness distribution value of paint coating thickness of each portion of an object to be painted;
determining an amount of adhered paint, which is the paint adhered to the object to be painted, based on the coating thickness distribution value obtained from the coating thickness simulation and a paint area of the object to be painted; and
calculating weight of adhered solvent, which is the weight of the solvent adhered to the object to be painted, based on the amount of the adhered paint.

9. A solvent weight calculation method for calculating solvent weight of adhered paint, which is the solvent weight of the paint adhered to an object to be painted, characterized in that by a solvent weight calculation process comprised of the following procedures (1)-(4) based on the presumption that at least a coating thickness simulation is executed for calculating a coating thickness distribution value of paint coating thickness of each portion of the object to be painted:
(1) Said coating thickness distribution value obtained from said coating thickness simulation is multiplied by a paint area of the object to be painted to determine an amount of dried adhered paint, which is a bulking value of the dried paint adhered to the object to be painted.
(2) Said amount of dried adhered paint is multiplied by specific gravity of the dried paint to determine dry weight of the adhered paint.
(3) Said dry weight of the adhered paint is divided by a proportion of solidified paint to determine weight of the adhered paint.
(4) Said dry weight of the adhered paint is subtracted from said weight of the adhered paint to determine said solvent weight of the adhered paint.

10. A solvent weight calculation method for calculating solvent weight of adhered paint, which is the solvent weight of the paint adhered to an object to be painted, characterized in that by a solvent weight calculation process comprised of the following procedures (1)-(3) based on the presumption that at least a coating thickness simulation is executed for calculating a coating thickness distribution value of paint coating thickness of each portion of the object to be painted:
(1) Said coating thickness distribution value obtained from said coating thickness simulation, a paint area of the object to be painted, and specific gravity of dried paint are multiplied together to determine dry weight of the adhered paint.
(2) Said dry weight of the adhered paint is divided by a proportion of solidified paint to determine weight of the adhered paint.
(3) Said dry weight of the adhered paint is subtracted from said weight of the adhered paint to determine said solvent weight of the adhered paint.

11. A solvent weight calculation method for calculating solvent weight of adhered paint, which is the solvent weight of the paint adhered to an object to be painted, characterized in that by a solvent weight calculation process comprised of the following procedures (1) and (2) based on the presumption that at least a coating thickness simulation is executed for calculating a coating thickness distribution value of paint coating thickness of each portion of the object to be painted:
(1) Said coating thickness distribution value obtained from said coating thickness simulation, a paint area of the object to be painted, and specific gravity of dried paint are multiplied together, then divided by a proportion of solidified paint to determine weight of the adhered paint.
(2) Said weight of the adhered paint is multiplied by a proportion of non-solidified paint to determine said solvent weight of the adhered paint.

12. A solvent weight calculation method as defined in either one of claims 9-11, characterized in that said procedure (1) conducts an integration process using said coating thickness distribution value and said paint area.

13. A solvent weight calculation method as defined in either one of claims 8-11, characterized in that said solvent weight calculation process is conducted based on the coating thickness simulation results at a time when a paint-adhering efficiency, which is an efficiency of the paint adhering to the object to be painted, becomes relatively high by repeatedly executing the coating thickness simulation while changing input conditions.
